(19) United States
(12) Patent Application Publication
(10) Pub. No.: US 2025/0344910 A1
(43) Pub. Date: Nov. 13, 2025

(54) PUMP DISPENSER, DISCHARGE CONTAINER AND CONTENT-CONTAINING DISCHARGE CONTAINER

(71) Applicant: DAIWA CAN COMPANY, Tokyo (JP)

(72) Inventors: Saki Watanabe, Sagamihara-shi (JP); Takayuki Sonku, Sagamihara-shi (JP); Susumu Sato, Sagamihara-shi (JP)

(73) Assignee: DAIWA CAN COMPANY, Tokyo (JP)

(21) Appl. No.: 19/280,267

(22) Filed: Jul. 25, 2025

Related U.S. Application Data
(63) Continuation of application No. PCT/JP2024/002492, filed on Jan. 26, 2024.

(30) Foreign Application Priority Data
Jan. 27, 2023 (JP) 2023-011023

(51) Int. Cl. A47K 5/14; A47K 5/12

(52) U.S. Cl. CPC A47K 5/14; A47K 5/1205

(57) ABSTRACT

A pump dispenser includes an air cylinder, an air piston provided in the air cylinder to reciprocate, a liquid cylinder, a liquid piston provided in the liquid cylinder to reciprocate, a mixing chamber having a communication hole in an upper wall thereof and provided on the secondary side of the air piston and the liquid piston to mix a liquid material and air supplied by reciprocation of the air piston and the liquid piston, a porous body provided on the secondary side of the mixing chamber, and a nozzle including a flow path formed on the secondary side of the porous body and a discharge hole whose opening area is smaller than an opening area of the flow path to reciprocate thereby to cause the air piston and the liquid piston to reciprocate.

### CROSS-REFERENCE TO RELATED APPLICATION

This application is a Continuation Application of PCT Application No. PCT/JP2024/002492, filed Jan. 26, 2024 and based upon and claiming the benefit of priority from Japanese Patent Application No. 2023-011023, filed Jan. 27, 2023, the entire contents of all of which are incorporated herein by reference.

### FIELD

The present invention relates to a pump dispenser that discharges a liquid material in a foamy state, a discharge container and a content-containing discharge container.

### BACKGROUND

As disclosed in, for example, Jpn. Pat. Appln. KOKAI Publication No. 2019-177950, a pump dispenser that discharges a liquid material in a foamy state and a discharge container using the pump dispenser have been known. The discharge container discharges the foam that is pressure-fed by depressing a nozzle, and the discharged foam falls substantially vertically from the distal end of the nozzle when the nozzle is gently depressed. In addition, even if the nozzle is quickly depressed, the discharged foam is projected horizontally but is discharged only to the vicinity of the container. Therefore, the distance of the discharged foam foam cannot be increased, that is, the foam cannot be attached to a target distant from the nozzle, it cannot be sprayed onto a target vigorously near the nozzle, or the like

Furthermore, in order to form a good foam, a liquid material mixed with air needs to be pressure-feed from a mixing chamber for mixing the the air with the liquid material to a porous body (mesh holder) provided in a foam flow path at the outlet of the mixing chamber. The pressure at the time of pressure-feeding affects the quality of the foam.

### SUMMARY

According to one aspect of the present invention, a pump dispenser includes an air cylinder, an air piston provided in the air cylinder to reciprocate, a liquid cylinder, a liquid piston provided in the liquid cylinder to reciprocate, a mixing chamber having a communication hole in an upper wall thereof and provided on the secondary side of the air piston and the liquid piston to mix a liquid material and air supplied by reciprocation of the air piston and the liquid piston, a porous body provided on the secondary side of the mixing chamber, and a nozzle including a flow path formed on the secondary side of the porous body and a discharge hole whose opening area is smaller than an opening area of the flow path to reciprocate thereby to cause the air piston and the liquid piston to reciprocate.

According to another aspect of the present invention, a discharge container includes a container body which contains a liquid material, and the above-described pump dispenser which is fixed to the container body.

According to still another aspect of the present invention, a discharge container includes a liquid material, a container body which contains the liquid material, and the above-described pump dispenser which is fixed to the container body.

### BRIEF DESCRIPTION OF THE DRAWINGS

FIG. 1 is a side view with a partially sectional view, showing a configuration of a discharge container according to an embodiment of the present invention.

FIG. 2 is a front view showing a configuration of a pump dispenser of the discharge container.

FIG. 3 is a sectional view showing a configuration of the pump dispenser whose nozzle is located in a first position.

FIG. 4 is a sectional view showing a configuration of the pump dispenser whose nozzle is located in a second position.

FIG. 5 is a perspective view showing a configuration of a nozzle tip used in the pump dispenser.

FIG. 6 is a perspective view showing the configuration of the nozzle tip.

FIG. 7 is a front view showing the configuration of the nozzle tip.

FIG. 8 is a sectional view of the configuration of the nozzle tip taken along line VIII-VIII in FIG. 7.

FIG. 9 is a front view showing a configuration of another example of the nozzle tip.

FIG. 10 is a front view showing a configuration of another example of the nozzle tip.

FIG. 11 is an illustration of results of a first evaluation test of the discharge container.

FIG. 12 is an illustration of results of a second evaluation test of the discharge container.

FIG. 13 is an illustration of results of a third evaluation test of the discharge container.

FIG. 14 is an illustration of results of a fourth evaluation test of the discharge container.

FIG. 15 is a front view of a configuration of another modification to the nozzle tip.

### DETAILED DESCRIPTION

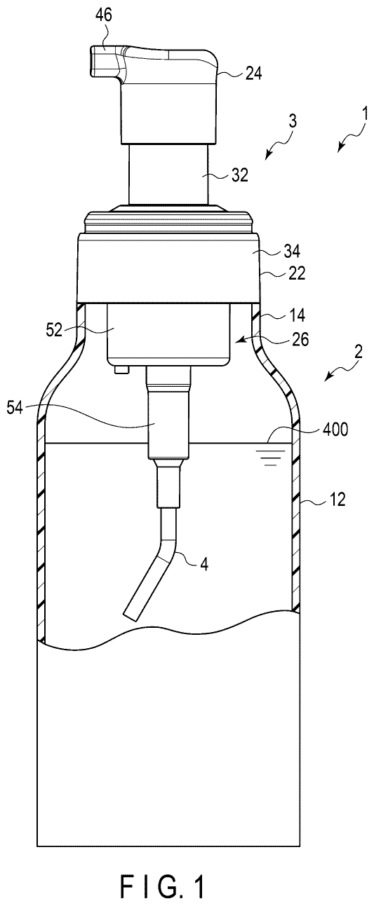

The configuration of a discharge container 1 according to an embodiment of the present invention will be described below with reference to FIGS. 1 to 10.

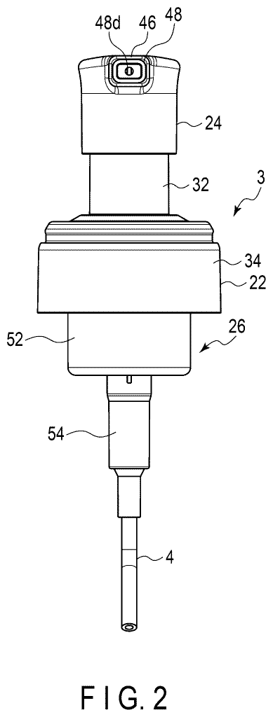

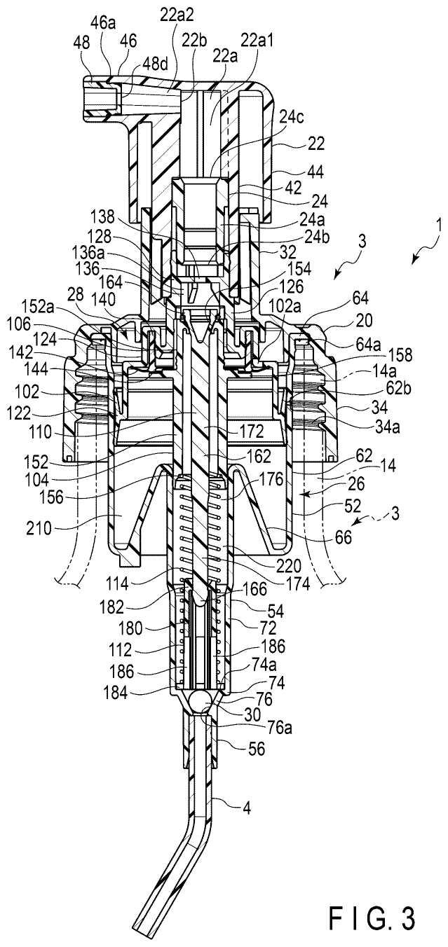

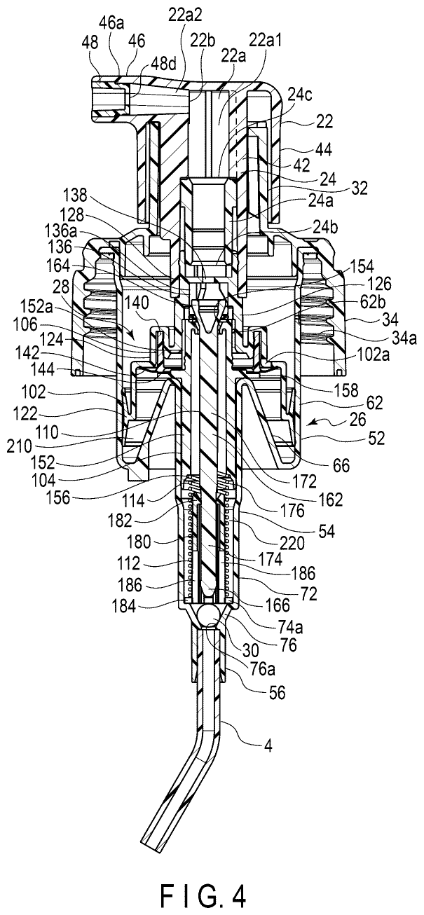

FIG. 1 is a side view with a partially sectional view, showing the configuration of the discharge container 1 according to the embodiment of the present invention. FIG. 2 is a front view showing a configuration of a pump dispenser 3 of the discharge container 1. FIG. 3 is a sectional view showing the configuration of the pump dispenser 3 whose nozzle 22 is located in a first position, and FIG. 4 is a sectional view showing the configuration of the pump dispenser 3 whose nozzle 22 is located in a second position.

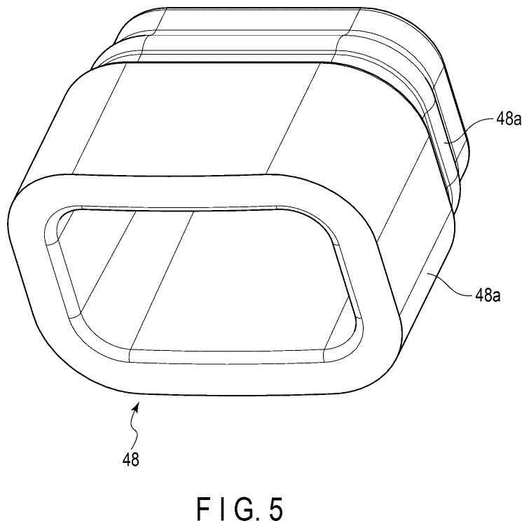

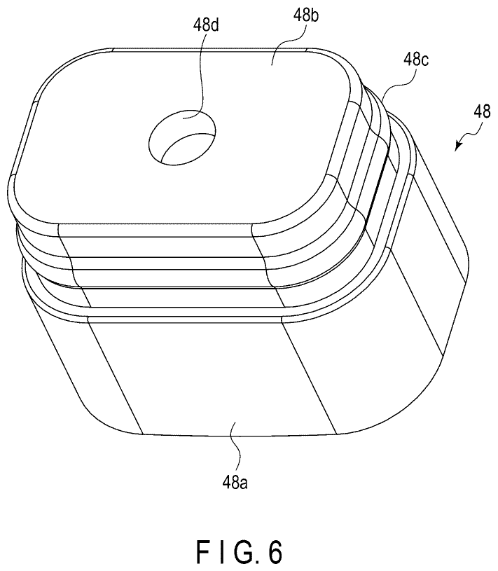

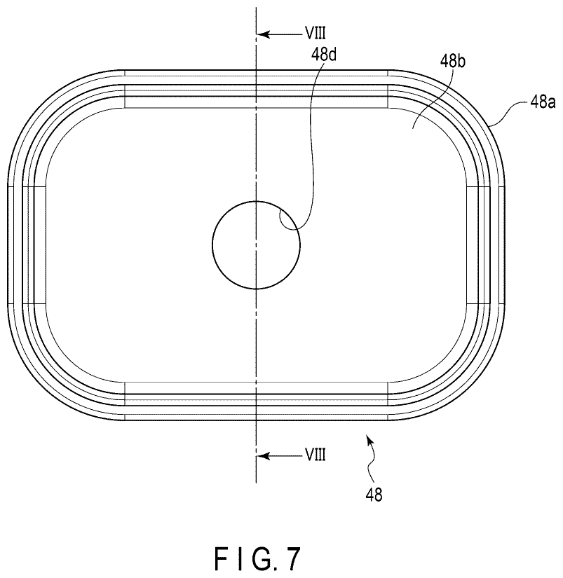

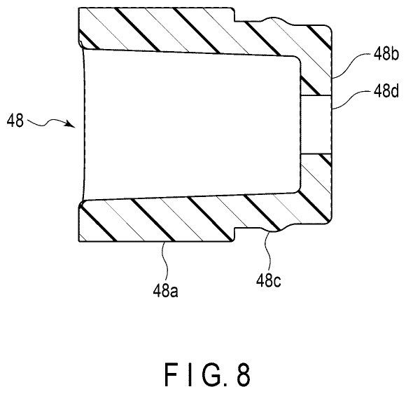

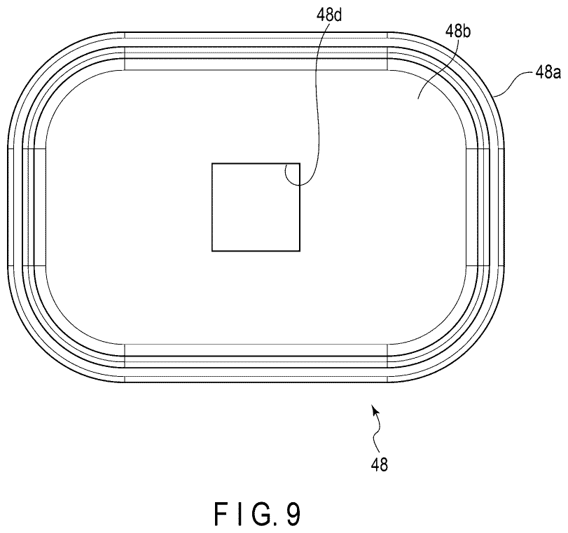

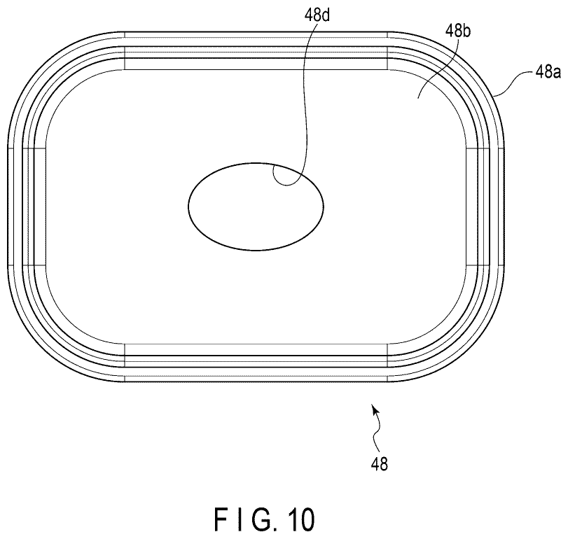

FIGS. 5 and 6 are perspective views showing a configuration of a nozzle tip 48 used in the pump dispenser 3 from different directions. FIG. 7 is a front view showing the configuration of the nozzle tip 48. FIG. 8 is a sectional view of the configuration of the nozzle tip 48 taken along line VIII-VIII in FIG. 7. FIG. 9 is a front view showing a configuration of another example of the nozzle tip 48, and FIG. 10 is a front view showing a configuration of another example of the nozzle tip 48. [Discharge Container]

As shown in FIG. 1, the discharge container 1 includes a container body 2, a pump dispenser 3 and a tube body 4. The discharge container 1 shown in FIG. 1 is a content-containing discharge container containing a liquid material 400 as a content.

The discharge container 1 is what is called a hand pump which uses the pump dispenser 3 to suck the liquid material 400 from the container body 2 through the tube body 4 and discharge the liquid material 400 in a foamy state. The present embodiment will be described below, defining the vertical direction with the container body 2 of the discharge container 1 located below and with the pump dispenser 3 located above.

The liquid material 400 is a content contained in the container body 2. The liquid material 400 is cosmetics, a detergent, medicines, quasi-drugs, a food and the like. Specific examples of the liquid material 400 include liquids containing surfactants such as shampoo, hand soap, facial cleanser and shaving cream.

The container body 2 has a bottomed tubular shape such as a bottomed cylindrical shape, but is not limited to a cylindrical shape as long as it can contain the liquid material 400. The container body 2 can contain the liquid material 400 inside. The container body 2 is formed of a resin material, a metal material, glass, ceramic or the like. The container body 2 includes a main body 12 in which the liquid material 400 is contained and a fixing portion 14 which is opened to project part of the top end of the main body 12. The fixing portion 14 is formed to fix the pump dispenser 3. As shown in FIG. 3, the fixing portion 14 has, for example, a male screw portion 14a on its outer peripheral surface.

As shown in FIGS. 1 to 4, the pump dispenser 3 includes a support unit 20, a nozzle 22, a mesh holder 24, a cylinder 26, a piston unit 28 and a spherical valve element 30. Note that the nozzle 22, mesh holder 24 and piston unit 28 constitute a stem that reciprocates along one direction relative to the support unit 20 and the cylinder 26.

The support unit 20 includes, for example, a cylindrical nozzle guide cylinder 32 and a fixed portion 34 which is shaped like a cylinder whose diameter is larger than that of the nozzle guide 32 and which is fixed to the fixing portion 14 of the container body 2. In the support unit 20, for example, the nozzle guide cylinder 32 extends from an opening at one end of the fixed portion 34 to the outside of the fixed portion 34. In other words, the nozzle guide cylinder 32 extends upward from the central side of the fixed portion 34. The nozzle guide cylinder 32 and the fixed portion 34 are integrally formed of, for example, a resin material. The nozzle guide cylinder 32 and the fixed portion 34 are, for example, coaxial with each other.

The nozzle guide cylinder 32 guides the nozzle 22 such that the nozzle 22 can be moved along the vertical direction, in other words, the nozzle 22 can be moved along the axis of the nozzle guide cylinder 32.

The fixed portion 34 gradually decreases in its diameter such that its upper end has a curved surface, for example. The fixed portion 34 includes a female screw portion 34a that is formed on the inner peripheral surface. The female screw portion 34a is screwed to the male screw portion 14a of the container body 2. Thus, the container body 2 and the pump dispenser 3 are formed detachably from each other. Note that the fixed portion 34 may be fixed to the container body 2. In addition, the discharge container 1 may have a cap for preventing the nozzle 22 from being operated erroneously and in this case, the fixed portion 34 has a fittable fitting portion on its outer peripheral surface.

The nozzle 22 is located above the support unit 20. The nozzle 22 includes an inner cylinder 42, an outer cylinder 44 whose diameter is larger than that of the inner cylinder 42, a discharge cylinder 46 that is fluidly continuous with the inner cylinder 42, and a nozzle tip 48 provided in the discharge cylinder 46. The inner cylinder 42, outer cylinder 44 and discharge cylinder 46 are integrally formed of, for example, a resin material. The inner diameter of the outer cylinder 44 is larger than the outside diameter of the nozzle guide cylinder 32.

The inner cylinder 42 and the discharge cylinder 46 form a flow path 22a through which a foamy liquid material 400 moves, which is continuous from the mesh holder 24 to the outside. The flow path 22a of the nozzle 22 includes, for example, a first flow path 22al formed in the inner cylinder 42 and extending along the moving direction of the nozzle 22 and a second flow path 22a2 extending in a direction intersecting with the first flow path 22al, which is orthogonal to the first flow path 22al in this embodiment.

Part of the lower end of the inner cylinder 42 is located at the interior of the nozzle guide cylinder 32 and is formed so as to reciprocate in one direction in the nozzle guide cylinder 32. The outer cylinder 44 reciprocates with respect to the support unit 20 between a first position (normal position) and a second position (pressing position) different from the first position along the axis of the nozzle guide cylinder 32. The inner and outer cylinders 42 and 44 are, for example, coaxial with each other.

The discharge cylinder 46 projects from the upper end of the inner cylinder 42 toward a direction intersecting with the axial center of the inner cylinder 42, for example, toward the side thereof. The flow-path sectional area of the discharge cylinder 46 gradually increases from the opening end of the second flow path 22a2 which is continuous with the inner cylinder 42 to the halfway point of the second flow path 22a2, specifically, to the nozzle tip 48. The discharge cylinder 46 is so formed that the nozzle tip 48 can be fit to the distal end thereof. As shown in FIGS. 1 to 4, the discharge cylinder 46 is formed in a rectangular cylinder shape, for example. As a specific example, as shown in FIG. 2, the discharge cylinder 46 is formed like a rectangular cylinder whose width is longer than the length thereof. Note that the discharge cylinder 46 may have a shape other than the rectangular cylinder, such as a cylinder, an elliptical cylinder and a polygonal cylinder other than the rectangle. The discharge cylinder 46 has an engaging portion 46a such as a projection and a groove, to which the nozzle tip 48 is fit, for example, on the inner peripheral surface on the tip side. The engaging portion 46a is, for example, an annular projection.

As shown in FIGS. 2 to 8, the nozzle tip 48 is formed in a bottomed cylindrical shape. The nozzle tip 48 is provided in the second flow path 22a2. As shown in FIGS. 3 and 4, the nozzle tip 48 is fit to the discharge cylinder 46 in such a manner that the axial direction of the nozzle tip 48 is the same as that of the discharge cylinder 46 (the axial direction of the second flow path 22a2). For example, as shown in FIG. 5, the nozzle tip 48 is formed in a bottomed rectangular cylinder shape whose width is longer than the length thereof since the discharge cylinder 46 is formed in a rectangular cylinder shape. The nozzle tip 48 has a peripheral wall portion 48a and a bottom wall portion 48b.

The peripheral wall portion 48a is formed in a rectangular cylinder shape. The peripheral wall portion 48a has, on its outer peripheral surface, an engaged portion 48c such as a projection or a groove, which is engaged with the engaging portion 46a of the discharge cylinder 46 and which is fit to the discharge cylinder 46. The inner space of the peripheral wall portion 48a forms a part of the second flow path 22a2.

The engaged portion 48c is formed by, for example, annular grooves and annular projections formed and arranged in the peripheral wall portion 48a in its axial direction. In other words, the annular grooves and projections are continuous because the outer portion of the engaged portion 48c is reduced alongside the bottom wall portion 48b of the peripheral wall portion 48a and the annular projections are formed adjacent to the reduced portion. If the engaging portion 46a is located in the groove of the engaged portion 48c, the projection of the engaged portion 48c and the engaging portion 46a are engaged in the axial direction of the discharge cylinder 46 and nozzle tip 48, and the nozzle tip 48 is fit to the discharge cylinder 46.

The bottom wall portion 48b is formed in a flat plate shape. The bottom wall portion 48b extends in a direction orthogonal to the axial direction of the discharge cylinder 46 while the nozzle tip 48 is fit to the discharge cylinder 46. A discharge hole 48d is formed in the bottom wall portion 48b. The thickness of the bottom wall portion 48b is, for example, 0.5 mm to 3.0 mm. This thickness range allows the rigidity of the bottom wall portion 48b to be maintained and allows the influence of a pressure loss of the foamy liquid material 400, which passes through the discharge hole 48d formed in the bottom wall portion 48b, to be minimized to ensure a suitable discharge distance.

The discharge hole 48d is provided in the flow path 22a formed in the nozzle 22. The discharge hole 48d is provided in the second flow path 22a2. The axial direction of the discharge hole 48d is, for example, along the axial direction of the peripheral wall portion 48a and the axial direction of the discharge cylinder 46 (the second flow path 22a2). The discharge hole 48d is formed from the distal end of the discharge cylinder 46 to the end thereof which is continuous with the inner cylinder 42 (the boundary between the first and second flow paths 22al and 22a2). That is, the discharge hole 48d is provided at the distal end of the discharge cylinder 46 or on the inner side of the discharge cylinder 46 toward the inner cylinder 42 from the distal end of the discharge cylinder 46. Preferably, the discharge hole 48d is provided on the inner side of the discharge cylinder 46 rather than the distal end thereof. The discharge hole 48d is formed, for example, at the center of the bottom wall portion 48b. The flow-path sectional area (opening area) of the discharge hole 48d is smaller than that of the inner cylinder 42, that of the discharge cylinder 46 and that of the peripheral wall portion 48a. The discharge hole 48d is, for example, a circular opening. In addition, for example, the inner diameter of the discharge hole 48d is constant.

The inner diameter of the discharge hole 48d ranges from 0.5 mm to 3.0 mm, more preferably from 1.0 mm to 2.0 mm. In other words, the flow-path sectional area (opening area) of the discharge hole 48d ranges from 0.19 mm² to 7.10 mm², more preferably from 0.78 mm² to 3.20 mm². Note that the discharge hole 48d may be a rectangular opening like that of a modification shown in FIG. 9 or may be an elliptical opening like that of another modification shown in FIG. 10. If the discharge hole 48d is rectangular, it may be square or oblong. The discharge hole 48d may be formed in another shape, such as a polygonal shape and an odd shape.

The mesh holder 24 is provided in the inner cylinder 42. The mesh holder 24 is provided on the primary side of the flow path 22a. The mesh holder 24 produces a good foamy liquid material 400 when the liquid material 400 and gas pass. The mesh holder 24 is supported at the interior of the inner cylinder 42, for example. The mesh holder 24 is a porous body including a cylindrical body 24a and two nets 24b and 24c each spaced apart from the body 24a. For example, the two nets 24b and 24c are fixed to both ends of the body 24a.

The cylinder 26 is supported on the lower side of the support unit 20. The cylinder 26 is cylindrical. The cylinder 26 includes a first cylinder (air cylinder) 52, a second cylinder (liquid cylinder) 54 having an inner peripheral surface whose diameter is smaller than that of the inner peripheral surface of the first cylinder 52 and an attachment cylinder 56 which has an inner peripheral surface whose diameter is smaller than that of the inner peripheral surface of the second cylinder 54 and to which the tube body 4 is attached. The first cylinder 52, second cylinder 54 and attachment cylinder 56 are integrally molded of, for example, a resin material. These cylinders 52, 54 and 56 are coaxial with one another and also coaxial with the support unit 20.

The first cylinder 52 includes a first slide portion 62 on which an air piston 102 (described later) of the piston unit 28 slides, a fixing end 64 supported between the outer peripheral surface of the nozzle guide cylinder 32 of the support unit 20 and the inner peripheral surface of the fixed portion 34, and a first annular unit 66 in which the lower end of the first cylinder 52 and the second cylinder 54 are continuous. The first slide portion 62 has a constant inner diameter, for example. In the first slide portion 62, a through hole 62b is so formed that it is closed by the air piston 102 at the first position and separated from the air piston 102 at the second position to communicate between the interior of the first cylinder 52 and that of the container body 2.

The fixing end 64 is provided at the upper end of the first slide portion 62 to continue with the first slide portion 62. The fixing end 64 is fit, for example, between the outer peripheral surface of the nozzle guide cylinder 32 of the support unit 20 and the inner peripheral surface of the fixed portion 34, and is supported on the upper end of the fixing portion 14 of the container body 2 via a packing 64a. The first annular unit 66 is provided below the first slide portion 62. The first slide portion 62 is integrally continuous with the outer peripheral edge of the first annular unit 66, the center side thereof is opened, and the second cylinder 54 is integrally continuous with the central side. For example, the first annular unit 66 is inclined with respect to the axial center from the outer peripheral edge side toward the opening on the central side such that the outer peripheral edge side is downward and the central side is upward.

The second cylinder 54 includes a second slide portion 72 on which a liquid piston 104 (described later) of the piston unit 28 slides, a plug seat portion 74 for supporting a plug 112 (described later) of the piston unit 28 and a second annular unit 76 which continues with the attachment cylinder 56.

The second slide portion 72 has a constant inner diameter, for example. The plug seat portion 74 has a seat surface 74a extending in a direction orthogonal to the axial center of the second cylinder 54. The seat surface 74a supports the plug 112 on its upper surface. The second annular unit 76 includes a valve seat 76a of the spherical valve element 30. The valve seat 76a abuts annularly with part of the outer peripheral surface of the spherical valve element 30.

The piston unit 28 is supported by the nozzle 22 and located in the support unit 20, nozzle 22 and cylinder 26. The piston unit 28 includes an air piston 102, a liquid piston 104, an air-chamber valve element 106, an inner rod 110, a plug 112 and an energizing member 114.

The air piston 102 is coaxial with the liquid piston 104. The air piston 102 includes an annular body portion 122, a holding portion 124 that holds the air-chamber valve element 106, a first fitting cylinder 126 that is fit to the liquid piston 104, and a second fitting cylinder 128 that is fit to the nozzle 22. The body portion 122, holding portion 124, first fitting cylinder 126 and second fitting cylinder 128 are integrally formed of, for example, a resin material. In addition, one or more through-holes 102a which penetrate the air piston 102 in the vertical direction are formed in part between the body portion 122 and the holding portion 124 of the air piston 102.

The body portion 122 slides on the inner peripheral surface of the first slide portion 62 of the cylinder 26 when the air piston 102 moves along the vertical direction (axial direction). The outer diameter of at least part of the body portion 122, for example, the outer diameters of the upper and lower ends of the body portion 122 are the same or slightly larger than the inner diameter of the inner peripheral surface of the first slide portion 62 of the cylinder 26. The body portion 122 is elastically deformed when it comes into contact with the first slide portion 62 of the cylinder 26, and can slide while maintaining contact with the inner peripheral surface of the first slide portion 62 of the cylinder 26 and sealing the air chamber 210.

The holding portion 124 is provided radially toward the inside of the body portion 122. The holding portion 124 is formed, for example, in a double cylindrical shape whose diameter is smaller than the inner diameter of the body portion 122, and holds the air-chamber valve element 106 that is fit between the inner and outer cylinders.

The diameter of the first fitting cylinder 126 is smaller than the inner diameter of the inner cylinder of the holding part 124. The first fitting cylinder 126 is fit to the upper end of the liquid piston 104. The upper ends of the liquid piston 104 and inner rod 110 are located inside the first fitting cylinder 126. The first fitting cylinder 126 forms inside a mixing chamber 136 for the supplied air and the liquid material 400, together with the upper end of the liquid piston 104. That is, a mixing chamber 136 for mixing the air supplied from the air piston 102 and the liquid material 400 supplied from the liquid piston 104 is formed on the secondary side of the air piston 102 and the secondary side of the liquid piston 104. The mixing chamber 136 communicates with the flow path 22a of the nozzle 22. In the first fitting cylinder 126, a communication hole 138 is formed in the upper part of the mixing chamber 136 to communicate the mixing chamber 136 and the flow path 22a of the nozzle 22.

The inner surface 136a of the mixing chamber 136 inside the first fitting cylinder 126 has an inclined surface, a rib or the like, which can press the valve element 164 of the inner rod 110. The inclined surface or rib of the mixing chamber 136 is inclined from the liquid piston 104 toward the flow path 22a of the nozzle 22 so as to reduce its inner diameter or width.

The communication hole 138 is formed in an upper wall formed above the mixing chamber 136. The communication hole 138 is formed, for example, at the center of the upper wall of the mixing chamber 136. The flow-path sectional area (opening area) of the communication hole 138 is smaller than the flow-path sectional area of the inner cylinder 42, that of the discharge cylinder 46 and that of the mixing chamber 136. The communication hole 138 is, for example, a circular opening.

The second fitting cylinder 128 is fit to, for example, the inner peripheral surface of the inner cylinder 42 of the nozzle 22. Thus, the air piston 102 moves with the movement of the nozzle 22.

The air-chamber valve element 106 is annularly formed and made of a resin material whose flexibility is higher than that of the air piston 102. The air-chamber valve element 106 includes a cylindrical portion 140 held by the holding portion 124 at a position below the holding portion 124, and an outer annular valve element 142 and an inner annular valve element 144 which are integrally formed at the lower end of the cylindrical portion 140.

The cylindrical portion 140 is fit into a gap between the outer and inner cylinders of the holding portion 124.

The outer annular valve element 142 is annularly formed to extend radially outward from the lower end of the cylindrical portion 140. The outer annular valve element 142 opens and closes the through hole 102a that serves as an air flow path of the air piston 102. The inner annular valve element 144 is annularly formed to extend radially inward from the lower end of the cylindrical portion 140.

The inner annular valve element 144 opens and closes an air flow path between the liquid piston 104 and the first fitting cylinder 126. The outer annular valve element 142 and the inner annular valve element 144 are elastically deformed by the change in air pressure caused by the movement of the nozzle 22, and open and close the air flow path.

The liquid piston 104 is fit into the first fitting cylinder 126 inside the air piston 102. The liquid piston 104 forms an air chamber 210 together with the first cylinder 52 of the cylinder 26 and the air piston 102. The liquid piston 104 also forms a liquid chamber 220 together with the second cylinder 54 of the cylinder 26. The liquid piston 104 reciprocates together with the air piston 102 according to the reciprocating movement of the nozzle 22 to change the volumes of the air chamber 210 and liquid chamber 220.

The liquid piston 104 includes a cylindrical body 152, a valve seat 154, a support seat 156 for supporting the upper end of the energizing member 114, and a flange 158 extending radially outward from the cylindrical body 152. The cylindrical body 152, valve seat 154, support seat 156 and flange 158 are integrally molded of, for example, a resin material.

The upper end portion of the cylindrical body 152 is fit to the first fitting cylinder 126 of the air piston 102. The outer peripheral surface of the upper end portion of the cylindrical body 152A is provided with a plurality of ribs 152a extending in the axial direction and projecting outward in the radial direction. The ribs 152a are provided between the upper end of the cylindrical body 152 and the flange 158. The ribs 152a are preferably formed at predetermined intervals in the circumferential direction on the outer peripheral surface of the upper end portion of the cylindrical body 152. In the ribs 152a that are adjacent in the circumferential direction, an air path permitting air flow is formed between the outer peripheral surface of the cylindrical body 152 of the liquid piston 104 and the first fitting cylinder 126 of the air piston 102 while the upper end portion of the cylindrical body 152 of the liquid piston 104 is fit to the first fitting cylinder 126 of the air piston 102. Note that the cylindrical body 152 may not include a plurality of ribs 152a for forming an air path, but may be configured to form an air path by a notch or the like formed inside the first fitting cylinder 126.

The outer diameter of the lower end portion of the cylindrical body 152 below the flange 158 is the same as or slightly larger than the inner diameter of the second slide portion 72 of the second cylinder 54 of the cylinder 26. Thus, the cylindrical body 152 of the liquid piston 104 slides on the inner peripheral surface of the second slide portion 72 of the second cylinder 54 of the cylinder 26 while sealing the liquid chamber 220.

The valve seat 154 is provided on the inner peripheral surface of the upper end of the cylindrical body 152. The valve seat 154 is annularly formed.

The support seat 156 is an annular seat surface extending in a direction orthogonal to the axial direction. The support seat 156 supports the upper end of the energizing member 114. The support seat 156 is provided inside the liquid piston 104. For example, the support seat 156 is located at an axially the same position as the flange 158.

As shown in FIGS. 3 and 4, the inner rod 110 includes a shaft body 162, a valve element 164 provided at the upper end of the shaft body 162 and a first engaging portion 166 provided at the lower end of the shaft body 162. The shaft body 162, valve element 164 and first engaging portion 166 are coaxial with one another. In addition, the shaft body 162, valve element 164 and first engaging portion 166 are integrally molded of a resin material.

The outer diameter of the shaft body 162 is smaller than the inner diameter of the liquid piston 104. The shaft body 162 includes, for example, a first shaft portion 172, a second shaft portion 174 and a shaft diameter changing portion 176. The first shaft portion 172 of the shaft body 162 is continuous with the valve element 164. The second shaft portion 174 of the shaft body 162 is continuous with the first engaging portion 166. The first shaft portion 172 and the second shaft portion 174 are formed in a columnar shape. The sectional area of the first shaft portion 172 continuing to the valve element 164 of the shaft body 162, which is orthogonal to the axial center of the first shaft portion 172, is larger than the sectional area of the second shaft portion 174 continuing to the first engaging portion 166. The shaft diameter changing portion 176 whose sectional area between the first and second shaft portions 172 and 174 of the shaft body 162 is changed, is formed in a tapered shape. The area of the shaft body 162 whose diameter is changed may be formed as a step. In addition, the second shaft portion 174 may includes a bead, a rib or the like as a reinforcing portion extending in the axial direction and projecting in the radial direction.

The valve element 164 is formed, for example, as a poppet valve. The longitudinal section of the valve element 164 including its axial center has a substantially triangular pyramidal shape or a substantially V-shaped shape having an inclined surface. The valve element 164 can be connected to and disconnected from the valve seat 154 of the liquid piston 104.

The sectional area of the first engaging portion 166 which is orthogonal to its axial center is larger than that of the second shaft portion 174 of the shaft body 162. The first engaging portion 166 is formed in a conical shape, a dome shape, a spherical shape, or the like.

As shown in FIGS. 3 and 4, the plug 112 includes a cylindrical body 180, a second engaging portion 182 that is a circular opening formed in the inner peripheral surface of the upper end of the body 180, and a flange portion 184 formed at the lower end thereof. The body 180, second engaging portion 182 and flange portion 184 are coaxial with one another.

On the lower end side of the body 180, a plurality of openings 186 are formed to serve as liquid paths for communicating the inside and outside of the plug 112. The openings 186 are formed in a rectangular shape extending along the axial direction. The inner diameter of the body 180 is larger than that of the second engaging portion 182.

The second engaging portion 182 is provided at the upper end of the body 180. It is an annular opening portion into which the first engaging portion 166 of the inner rod 110 is fit and which is engaged with the first engaging portion 166 in a direction apart from the inner rod 110 and the plug 112 in the axial direction.

The flange portion 184 is supported by the seat surface 74a of the plug seat portion 74. The outer diameter of the flange portion 184 is smaller than the inner diameter of the second cylinder 54 of the cylinder 26. The outer diameter of the flange portion 184 is larger than the inner diameter of the valve seat 76a of the second annular portion 76 of the second cylinder 54. Thus, the plug 112 is supported by the plug seat portion 74 with the flange portion 184 on the lower side.

Next is a description of specific examples of the discharge hole 48d formed in the nozzle 22 of the pump dispenser 3 configured as described above and the communication hole 138 formed in the mixing chamber 136 will be described.

For example, the discharge hole 48d is formed to have the smallest flow-path sectional area of the flow path 22a of the nozzle 22 on the secondary side of the communication hole 138. If a portion of the flow path 22a of the nozzle 22 having the smallest flow-path sectional area from the secondary side of the communication hole 138 to the discharge hole 48d is a reference portion 22b, the flow-path sectional area of the discharge hole 48d is smaller than that of the reference portion 22b. In the present embodiment, the reference portion 22b is a portion where the first flow path 22al in the inner cylinder 42 and the second flow path 22a2 in the discharge cylinder 46 intersect with each other.

As a specific example, the flow-path sectional area of the discharge hole 48d is set in the range of 0.5% to 40% of the flow-path sectional area of the reference portion 22b. More preferably, the flow-path sectional area of the discharge hole 48d is set in the range of 0.5% to 20% of the flow-path sectional area of the reference portion 22b.

In addition, the discharge hole 48d is the same as the communication hole 138 or smaller than the communication hole 138. In other words, the flow-path sectional area of the discharge hole 48d is equal to or smaller than that of the communication hole 138. In the present embodiment, the thickness of the bottom wall portion 48b in which the discharge hole 48d is formed is 0.8 mm, and the thickness of the wall in which the communication hole 138 is formed is 1.0 mm.

The flow-path sectional area of the communication hole 138 is smaller than that of the reference portion 22b. As a specific example, the flow-path sectional area of the discharge hole 48d is set in the range of 2% to 60% of the flow-path sectional area of the reference portion 22b. More preferably, the flow-path sectional area of the discharge hole 48d is set in the range of 2% to 40% of the flow-path sectional area of the reference portion 22b.

In addition, the flow-path sectional area of the second flow path 22a2 in the discharge cylinder 46 gradually increases from the reference portion 22b (the primary side of the second flow path 22a2) to the discharge hole 48d. The flow-path sectional area of the nozzle tip 48, which is part of the second flow path 22a2, in the peripheral wall portion 48a gradually increases from the discharge hole 48d to the distal end of the nozzle tip 48 (the distal end of the discharge cylinder 46).

The discharge container 1 thus configured has the discharge hole 48d whose flow-path sectional area is smaller than that of the flow path 22a in the nozzle 22. In the discharge container 1, if the discharge hole 48 increases the pressure of the foamy liquid material 400 through which the mesh holder (porous body) 24 has passed, the discharge distance of the foamy liquid material 400 can be lengthened while maintaining the foamy quality. Thus, the discharge container 1 can cause the foamy liquid material 400 to be attached to a target separated from the nozzle 22.

The discharge container 1 includes the communication hole 138 on the primary side of the mesh holder 24 and on the secondary side of the mixing chamber 136. Thus, the discharge container 1 can further increase the discharge distance of the foamy liquid material 400. The discharge container 1 can also increase the discharge distance of the foamy liquid material 400 by the discharge hole 48d provided from the distal end of the discharge cylinder 46 to the end portion of the discharge cylinder 46 which is continuous to the inner cylinder 42. In addition, the discharge container 1 can further increase the discharge distance of the foamy liquid material 400 by the discharge hole 48d provided inside the distal end of the discharge container 1, as compared with the configuration in which the discharge hole 48d is provided at the distal end of the discharge hole 48d.

The nozzle 22 has a shape in which the flow-path sectional area of the second flow path 22a2 on the secondary side of the discharge hole 48d, that is, the inner diameter of the peripheral wall portion 48a, gradually increases from the main surface of the bottom wall portion 48b alongside the discharge hole 48d toward the distal end of the discharge cylinder 46. Thus, the foamy liquid material 400 that has passed through the discharge hole 48d can be prevented from coming into contact with the inner surface of the peripheral wall portion 48a during discharge, so that the discharge distance can be prevented from decreasing due to the contact with the peripheral wall portion 48a during discharge.

[Evaluation Test of Discharge Container 1] Next is a description of evaluation tests and evaluation results of the discharge container configured as described above. It should be noted that the evaluation tests are intended to describe the advantages of the present embodiment more specifically, and the scope of the present invention is not limited to the following examples.

### [First Evaluation Test]

As a first evaluation test, three kinds of pump dispensers 3 having different discharge amounts (g) of the liquid material 400 were used to evaluate the presence or absence of the discharge hole 48d and the discharge distance (mm) of a foamy liquid material 100 with respect to the diameter (mm) of the discharge hole 48d.

The discharge amounts of the three kinds of pump dispensers 3 were 0.95 g, 0.80 g and 0.45 g. The following description is made defining the pump dispenser 3 whose discharge amount is 0.95 g as pump A, the pump dispenser 3 whose discharge amount is 0.80 g as pump B, and the pump dispenser whose discharge amount is 0.45 g as pump C. Note that the discharge amounts of the pumps A to C are caused to differ by causing the diameters of the cylinder 26 and piston unit 28 to differ and making the stroke amounts of the piston unit 28 (nozzle 22) the same.

As an example, in the pumps A to C, three kinds of nozzle tips 48 were used in which the diameters of the discharge holes 48d were 1.0 mm, 2.0 mm and 3.0 mm and the axial length of each of the discharge holes 48d was 0.8 mm. Further, as a comparative example, pumps A to C having no discharge hole 48d like a prior art pump dispenser were used. The pumps A-C having no discharge hole 48d are pumps A-C having no nozzle tip 48 in the discharge cylinder 46.

In each of the pumps A to C, the inner diameter of the mixing chamber 136 was 6.4 mm, the diameter of the communication hole 138 was 2.0 mm and the axial length of the communication hole 138 was 1.0 mm.

In the liquid material 400 to be used, MONOGEN Y-500T (manufactured by DKS Co. Ltd.) (registered trademark) was used as surfactant.

Then, the nozzles 22 of the pumps A to C were each operated at 50 mm/sec to measure the discharge distance of the foamy liquid material 400 three times and obtain the average value thereof.

### [Results of First Evaluation Test]

FIG. 11 shows the results of the first evaluation test. First is a description of the results of the first evaluation test for the pump A. As a comparative example, in the pump A having no discharge hole 48d, the discharge distance of the foamy liquid material 400 was 140 mm. In contrast to this, in the pump A having the discharge hole 48d as the example, the discharge distance was 1275 mm if the diameter of the discharge hole 48d was 1.0 mm, the discharge distance was 1156 mm if the diameter of the discharge hole 48d was 2.0 mm, and the discharge distance was 493 mm if the diameter of the discharge hole 48d was 3.0 mm.

It is clear from the above that in the pump A having the discharge hole 48d, the discharge distance of the foamy liquid material 400 is lengthened as compared with the pump A having no discharge hole 48d. It is also clear that the discharge distance decreases as the diameter of the discharge hole 48d increases. It is therefore clear that the discharge distance can be adjusted by adjusting the diameter of the discharge hole 48d.

Next is a description of the results of the first evaluation test for the pump B. As a comparative example, in the pump B having no discharge hole 48d, the discharge distance of the foamy liquid material 400 was 112 mm. In contrast to this, in the pump B having the discharge hole 48d as the example, the discharge distance was 1597 mm if the diameter of the discharge hole 48d was 1.0 mm, the discharge distance was 1563 mm if the diameter of the discharge hole 48d was 2.0 mm, and the discharge distance was 760 mm if the diameter of the discharge hole 48d was 3.0 mm.

It is clear from the above that in the pump B having the discharge hole 48d, the discharge distance of the foamy liquid material 400 is lengthened as compared with the pump B having no discharge hole 48d. It is also clear that the discharge distance decreases as the diameter of the discharge hole 48d increases from 1.0 mm to 3.0 mm. It is therefore clear that the discharge distance can be adjusted by adjusting the diameter of the discharge hole 48d.

Next is a description of the results of the first evaluation test for the pump C. As a comparative example, in the pump C having no discharge hole 48d, the discharge distance of the foamy liquid material 400 was 100 mm. In contrast to this, in the pump C having the discharge hole 48d as the example, the discharge distance was 1778 mm if the diameter of the discharge hole 48d was 1.0 mm, the discharge distance was 802 mm if the diameter of the discharge hole 48d was 2.0 mm, and the discharge distance was 157 mm if the diameter of the discharge hole 48d was 3.0 mm.

It is clear from the above that in the pump C having the discharge hole 48d, the discharge distance of the foamy liquid material 400 is lengthened as compared with the pump C having no discharge hole 48d. It is also clear that the discharge distance decreases as the diameter of the discharge hole 48d increases from 1.0 mm to 3.0 mm. It is therefore clear that the discharge distance can be adjusted by adjusting the diameter of the discharge hole 48d.

It is also clear from the results of the evaluation tests for the pumps A to C that the discharge hole 48d makes it possible to lengthen the discharge distance of the foamy liquid material 400 regardless of the discharge amount of the pump dispenser 3 and to adjust the discharge distance according to the diameter of the discharge hole 48d. In the pump C, if the diameter of the discharge hole 48d is 3.0 mm, the discharge distance is lengthened by only 50 mm as compared with the absence of the discharge hole 48d. In each of the pumps A to C, too, if the diameter of the discharge hole 48d is 2.0 mm and 3.0 mm, a difference in the discharge distance between them is large. To secure the discharge distance, therefore, the diameter of the discharge hole 48d is preferably 3.0 mm or less, and more preferably 2.0 mm or less. If, however, the discharge hole 48d is provided, the discharge distance is lengthened as compared with the absence of the discharge hole 48d. Thus, the diameter of the discharge hole may be 3.0 mm or longer depending on a desired discharge distance.

### [Second Evaluation Test]

As a second evaluation test, three kinds of pumps A to C having different discharge amounts (g) of the liquid material 400 were used to evaluate the foam density (g/cm³) of the foamy liquid material 100 with respect to the diameter (mm) of the discharge hole 48d.

In the second evaluation test, the same pumps A to C as those in the first evaluation test were used, and in the pumps A to C, three kinds of nozzle tips 48 were used in which the diameters of the discharge holes 48d were 1.0 mm, 2.0 mm and 3.0 mm and the axial length of the discharge holes 48d was 0.8 mm.

In the liquid material 400 to be used, MONOGEN Y-500T (manufactured by DKS Co. Ltd.) (registered trademark) was used as surfactant.

Then, the nozzles 22 of the pumps A to C were each operated at 50 mm/sec and the foamy liquid material 400 was put into a predetermined container whose internal volume was measured to the full level to measure the weight of the foamy liquid material 400 three times and thus obtain the average value thereof.

From the discharge amounts of the pumps A to C, the standard value of the foam density in the pump A is 0.095 g/cm³+0.015 g/cm³, the standard value of the foam density in the pump B is 0.08 g/cm³+0.015 g/cm³, and the standard value of the foam density in the pump C is 0.045 g/cm³+0.015 g/cm³.

### [Results of Second Evaluation Test]

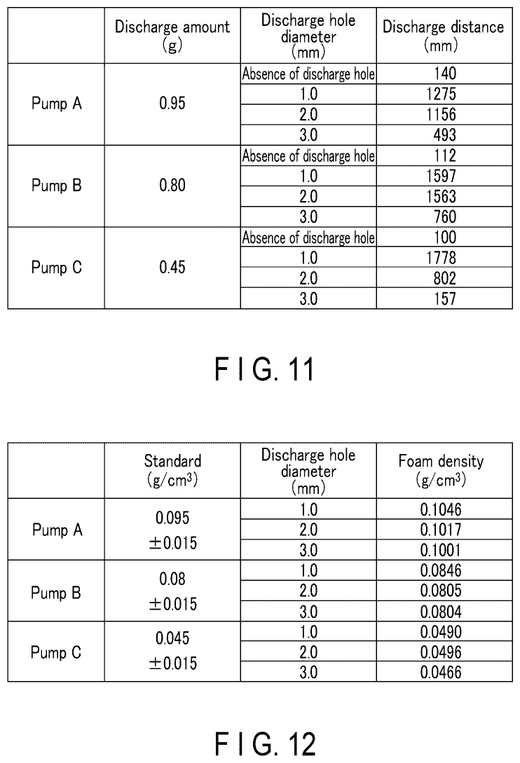

FIG. 12 shows the results of the second evaluation test. In the pump A having the discharge hole 48d, the foam density was 0.1046 g/cm³ if the diameter of the discharge hole 48d was 1.0 mm, the foam density was 0.1017 g/cm³ if the diameter of the discharge hole 48d was 2.0 mm, and the foam density was 0.1001 g/cm³ if the diameter of the discharge hole 48d was 3.0 mm.

In the pump B having the discharge hole 48d, the foam density was 0.0846 g/cm³ if the diameter of the discharge hole 48d was 1.0 mm, the foam density was 0.0805 g/cm³ if the diameter of the discharge hole 48d was 2.0 mm, and the foam density was 0.0804 g/cm³ if the diameter of the discharge hole 48d was 3.0 mm.

In the pump C having the discharge hole 48d, the foam density was 0.0490 g/cm³ if the diameter of the discharge hole 48d was 1.0 mm, the foam density was 0.0496 g/cm³ if the diameter of the discharge hole 48d was 2.0 mm, and the foam density was 0.0466 g/cm³ if the diameter of the discharge hole 48d was 3.0 mm.

The foam density falls within the range of the standard value in the diameter of the discharge hole 48d of each of the pumps A to C. It is clear from this that even if the discharge hole 48d is provided, the foam quality of the foamy liquid material 400 is favorable and the stability of the foam quality can be ensured.

### [Third Evaluation Test]

As a third evaluation test, the discharge distance (mm) of the foamy liquid material 100 was evaluated with respect to the presence or absence of the communication hole 138 using the pump dispenser 3.

The pump dispenser 3 uses two pumps A having a discharge amount of 0.95 g, the diameter (mm) of the discharge hole 48d is 1.0 mm and the inner diameter of the mixing chamber 136 is 6.4 mm. In one of the pumps A (having a communication hole 138), the diameter of the communication hole 138 is 2.0 mm, and in the other pump A (without having the communication hole 138), the upper end of the mixing chamber 136 is opened with the same diameter (6.4 mm) as the inner diameter of the mixing chamber 136 (that is, the mixing chamber 136 has no upper wall).

In the liquid material 400 to be used, MONOGEN Y-500T (manufactured by DKS Co. Ltd.) (registered trademark) was used as surfactant.

Then, the nozzles 22 of the pumps A to C were each operated at 50 mm/sec to measure the discharge distance of the foamy liquid material 400 three times and obtain the average value thereof.

### [Results of Third Evaluation Test]

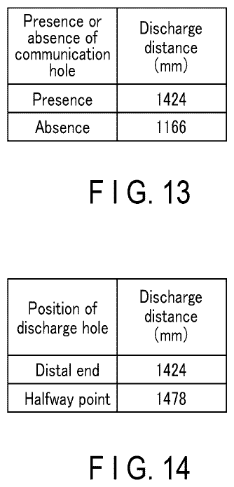

FIG. 13 shows the results of a third evaluation test. In the pump A having the communication hole 138, the discharge distance of the foamy liquid material 400 was 1424 mm. In contrast to this, in the pump A having no communication hole 138, the discharge distance of the foamy liquid material 400 was 1166 mm.

It is clear from the above that the discharge distance of the liquid material 400 can be lengthened by the communication hole 138 formed on the secondary side of the mixing chamber 136 and on the primary side of the mesh holder 24. This is because the velocity of the liquid material 400 mixed with air that passes through the mixing chamber 136 and enters the mesh holder 24 is increased, thereby increasing the pressure and velocity of the liquid material 400.

### [Fourth Evaluation Test]

As a fourth evaluation test, the discharge distance (mm) of the foamy liquid material 100 with respect to the position of the discharge hole 48d was evaluated using the pump dispenser 3.

The pump dispenser 3 uses two pumps A having a discharge amount of 0.95 g, the diameter (mm) of the discharge hole 48d is 1.0 mm, the inner diameter of the mixing chamber 136 is 6.4 mm and the diameter of the communication hole 138 is 2.0 mm. In one of the pumps A, the discharge hole 48d is located at the distal end of the discharge cylinder 46 (the second flow path 22a2). In the other pump A, the discharge hole 48d is located inside the distal end of the discharge cylinder 46 (the second flow path 22a2) (it is located halfway in the second flow path 22a2) and at the reference portion 22b (the boundary between the first flow path 22al and the second flow path 22a2) of the discharge cylinder 46.

In the liquid material 400 to be used, MONOGEN Y-500T (manufactured by DKS Co. Ltd.) (registered trademark) was used as surfactant.

Then, the nozzles 22 of the pumps A to C were each operated at 50 mm/sec to measure the discharge distance of the foamy liquid material 400 three times and obtain the average value thereof.

### [Results of Fourth Evaluation Test]

FIG. 14 shows the results of the fourth evaluation test. In the pump A whose discharge hole 48d is provided at the distal end of the discharge cylinder 46, the discharge distance of the foamy liquid material 400 was 1424 mm. In contrast to this, in the pump A whose discharge hole 48d is provided halfway in the discharge cylinder 46, the discharge distance of the foamy liquid material 400 was 1478 mm.

It is clear from the above that the discharge distance of the foamy liquid material 400 can be lengthened by the discharge hole 48d provided inside the distal end of the discharge cylinder 46.

As described above, in the discharge container 1 according to the embodiment, the discharge hole 48d is formed in the nozzle 22. It is thus clear that the discharge distance of foam can be increased while maintaining the stability of the foam quality.

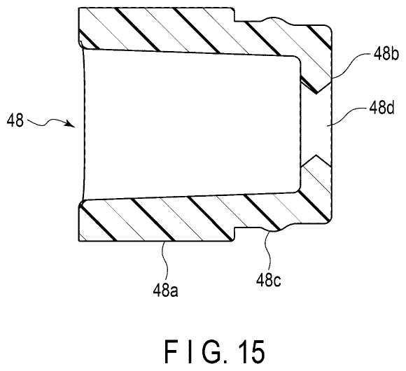

Note that the present invention is not limited to the foregoing embodiment. For example, in the example described above, the discharge hole 48d is an opening having a constant inner diameter in the axial direction, but it is not limited to the opening. For example, as in the modification shown in FIG. 15, the discharge hole 48d may be an opening whose diameter varies in the axial direction. For example, in the example of FIG. 15, the discharge hole 48d is so shaped that its central part has the smallest diameter (width) in the axial direction, but may be so shaped that its either side is the smallest in the axial direction, for example.

Furthermore, in the foregoing example, the discharge hole 48d provided in the nozzle 22 is provided in the nozzle tip 48, but this is not a limitation. That is, the discharge hole 48d may be integrally molded with the discharge cylinder 46 by projecting the inner peripheral surface of the discharge cylinder 46 of the nozzle 22, or a member having the discharge hole 48d, such as an orifice plate may be provided in the discharge cylinder 46 (nozzle 22) by insert molding. In addition, the wall around the discharge hole 48d extends in a direction orthogonal to the axial direction of the discharge hole 48d (second flow path 22a2), but this is not a limitation, and may be inclined with respect to the axial direction of the discharge hole 48d (second flow path 22a2).

In the foregoing example, the discharge container 1 discharges the liquid material 400 in the form of foam. However, even in a configuration in which the liquid material 400 that is not in the form of foam is used and the liquid material 400 is discharged in the form of liquid, the advantage of increasing the discharge distance can be obtained.

The present invention is not limited to the foregoing embodiments, and can be modified in various ways without departing from the spirit of the invention when the invention is reduced to practice. The embodiments may be combined as appropriate and in this case the combination may bring about an advantageous effect. In addition, the embodiments include a variety of inventions, and the inventions can be extracted by combining a plurality of selected structural elements to be disclosed. For example, even though some of the structural elements of the embodiments are omitted, the problems of the invention can be solved, and if the advantageous effects are obtained, a configuration excluding the omitted structural elements may be extracted as an invention.

What is claimed is:

1. A pump dispenser comprising:
an air cylinder;
an air piston provided in the air cylinder to reciprocate;
a liquid cylinder;
a liquid piston provided in the liquid cylinder to reciprocate;
a mixing chamber having a communication hole in an upper wall thereof and provided on a secondary side of the air piston and the liquid piston to mix a liquid material and air supplied by reciprocation of the air piston and the liquid piston;
a porous body provided on a secondary side of the mixing chamber; and
a nozzle including a flow path formed on a secondary side of the communication hole and a discharge hole whose opening area is smaller than an opening area of the flow path to reciprocate thereby to cause the air piston and the liquid piston to reciprocate.

2. The pump dispenser of claim 1, wherein the discharge hole has a flow-path sectional area which is equal to or smaller than a flow-path sectional area of the communication hole.

3. The pump dispenser of claim 1, wherein the discharge hole has a diameter of 0.5 mm to 3.0 mm.

4. The pump dispenser of claim 1, wherein the discharge hole has a diameter in a range of 0.5% to 40% of a diameter of a portion of the flow path whose flow-path sectional area is smallest.

5. The pump dispenser of claim 1, wherein the communication hole has a diameter in a range of 2% to 60% of a diameter of a portion of the flow path whose flow-path sectional area is smallest.

6. The pump dispenser of claim 1, wherein:
the flow path includes a first flow path along a moving direction of the nozzle and a second flow path along a direction intersecting with the first flow path;
the discharge hole is provided in the second flow path; and
an axial direction of the discharge hole is along an axial direction of the second flow path.

7. The pump dispenser of claim 6, wherein the discharge hole is provided halfway in the second flow path.

8. The pump dispenser of claim 7, wherein a flow-path sectional area of the second flow path on the secondary side of the discharge hole gradually increases from the discharge hole side toward a distal end.

9. The pump dispenser of claim 1, wherein the nozzle has a cylindrical nozzle tip which is provided in the flow path and in which the discharge hole is formed.

10. The pump dispenser of claim 9, wherein:
The secondary side of the discharge hole of the nozzle tip forms part of the flow path; and
a secondary-side flow-path sectional area of the discharge hole of the nozzle tip gradually increases from the discharge hole toward the distal end.

11. A discharge container comprising:
a container body which contains a liquid material; and
the pump dispenser of claim 1, which is fixed to the container body.

12. A discharge container comprising:
a liquid material;
a container body which contains the liquid material; and
the pump dispenser of claim 1, which is fixed to the container body.
